(19) United States
(12) Patent Application Publication
(10) Pub. No.: US 2024/0259183 A1
(43) Pub. Date: Aug. 1, 2024

(54) SIMILARITY HASHING OF BINARY FILE FEATURE SETS FOR CLUSTERING AND MALICIOUS DETECTION

(71) Applicant: Palo Alto Networks, Inc., Santa Clara, CA (US)

(72) Inventors: Nelson William Gamazo Sanchez, Stittsville (CA); Nathaniel John Quist, Westminster, CO (US); Ariel M. Zelivansky, Mountain View, CA (US)

(21) Appl. No.: 18/161,238

(22) Filed: Jan. 30, 2023

(51) Int. Cl. H04L 9/06

(52) U.S. Cl. CPC H04L 9/0643

(57) ABSTRACT

Locality sensitive hashing of feature sets generated from disassembly binary files results in hashes that capture similar and dissimilar functionality across binary files. Comparing hashes of binary files allows for malicious detection by identifying binary files with similar hashes to known malicious binary files. Scalable storage and clustering of hashes using approximate nearest neighbor search in a vector database allows for classification of large stores of binary files according to cluster labels. Storage of verdicts from the clustering and other metadata in a non-relational database further allows for scalable analysis of strata of binary files according to criteria on complex binary file metadata.

### BACKGROUND

The disclosure generally relates to CPC class G06F and subclass 21/50 and/or 21/56.

Locality sensitive hashing is a class of hashing algorithms that, in contrast to typical hashing algorithms that seek to minimize collisions between hashes of distinct inputs, promotes similar inputs mapping to similar hashes and dissimilar inputs mapping to dissimilar hashes. The notions of “similar” and “dissimilar” are according to metrics on the space of inputs and the space of hashes. An example locality sensitive hashing algorithm is the min-wise independent permutations locality sensitive hashing scheme (MinHash). The goal of MinHash is that the distance between hashes of two inputs to MinHash is approximately the Jaccard distance between the inputs. The inputs to MinHash are sets—for instance, a set of characters or strings—and the outputs are binary vectors. The Jaccard distance is a metric that quantifies similarity between two sets as the number of elements in their intersection divided by the number of elements in their union.

### BRIEF DESCRIPTION OF THE DRAWINGS

Embodiments of the disclosure may be better understood by referencing the accompanying drawings.

FIG. 1 is a schematic diagram of an example system for labelling and clustering of binary files according to similarity hashes of feature sets of binary files.

FIG. 2 is a flowchart of example operations for analyzing binary files according to similarity hashes.

FIG. 3 is a flowchart of example operations for generating a binary file verdict with ANN search.

FIG. 4 is a flowchart of example operations for generating a hash vector for a binary file with features sets corresponding to software artifacts.

FIG. 5 is a flowchart of example operations for clustering hash vectors according to ANN results for a vector database and labelling the clusters.

FIG. 6 is a flowchart of example operations for querying a vector database for ANNs of a hash vector.

FIG. 7 depicts an example computer system with a binary file hashing/analysis system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Malicious binary file detection suffers from challenges with scalability as thousands if not millions of binary files are inspected daily. Moreover, typical hashing schemes to compare binary files such as fuzzy hashing operate on unmanipulated binary file code, which loses information such as metadata and functionality of code blocks within binary files. A binary file analysis pipeline that is described herein enables hashing of binary files at scale with accurate exact/approximate matches between binary files for classification according to cluster labels generated from ground truth verdicts. When a binary file is detected, a disassembler generates artifacts from the binary file including a control flow graph and metadata corresponding to each code block contained in the binary file. The disassembler then generates feature sets from values of features derived from the artifacts.

Subsequently, MinHash is applied to each of the feature sets individually and the resulting hashes (i.e., binary vectors) constitute a length-256 hash vector for the binary file. This hash vector is stored in a vector database and an approximate nearest neighbor search on each of the hashes in the hash vector is performed to determine approximate or exact matches for hashes of other binary files. The binary file is associated with a verdict corresponding to a cluster label for one of the binary files returned from the approximate nearest neighbor search with the closest hash. This allows for efficient, scalable (due to scalability of the vector database) triage of binary files to quickly flag potentially malicious binary files. Moreover, using hashes of feature sets from binary file artifacts captures similarity in functionality of binary files not necessarily present in binary file code.

Periodically, the clusters are updated according to hash vectors added to the vector database and relabeled according to ground truth labels of binary files corresponding to hashes within each updated cluster. Clusters corresponding to malicious binaries are further associated with indicators of compromise (IOCs) for those binary files with hash vectors in the clusters. A non-relational database is populated with identifiers of each binary file (stored as cryptographic hashes of the binary files), along with other metadata including cluster identifiers, binary file type/architecture/size, and corresponding IOCs for malicious binary files. Ongoing updating of the non-relational database according to updated clusters enables up-to-date analysis of frequent IOCs and other vectors across the attack surface of binary files. Moreover, generation of hashes using multiple MinHash applications across multiple feature sets corresponding to artifact types of binary files allows for accurate binary file comparison and, consequently, improved verdict quality.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

An “artifact” or “software artifact” herein refers to any data or byproduct generated during execution or development of a binary file. This includes byproducts from disassembly such as control flow graphs that map execution of binary files and assembly code.

A “feature set” herein refers to values of a feature occurring multiple times in a binary file. Feature sets have variable length across binary files because more or less instances of a feature can occur, for instance, more or less referenced strings can occur in distinct binary files. Values of features within each feature set are derived from artifacts of the binary files, for instance derived from functions contained in assembly code for the binary files. Certain binary files can have empty or null feature sets when the corresponding feature has no values in the binary file (e.g., unnamed functions).

A “hash vector” herein refers to a data structure for storing multiple hashes of feature sets for a binary file. While feature sets have variable length, their hashes are fixed length and thus each has vector has a fixed length according to how may feature sets are present in the corresponding binary file. Any appropriate data structure for storing the hashes in association with the binary file can be implemented as a hash vector.

### Example Illustrations

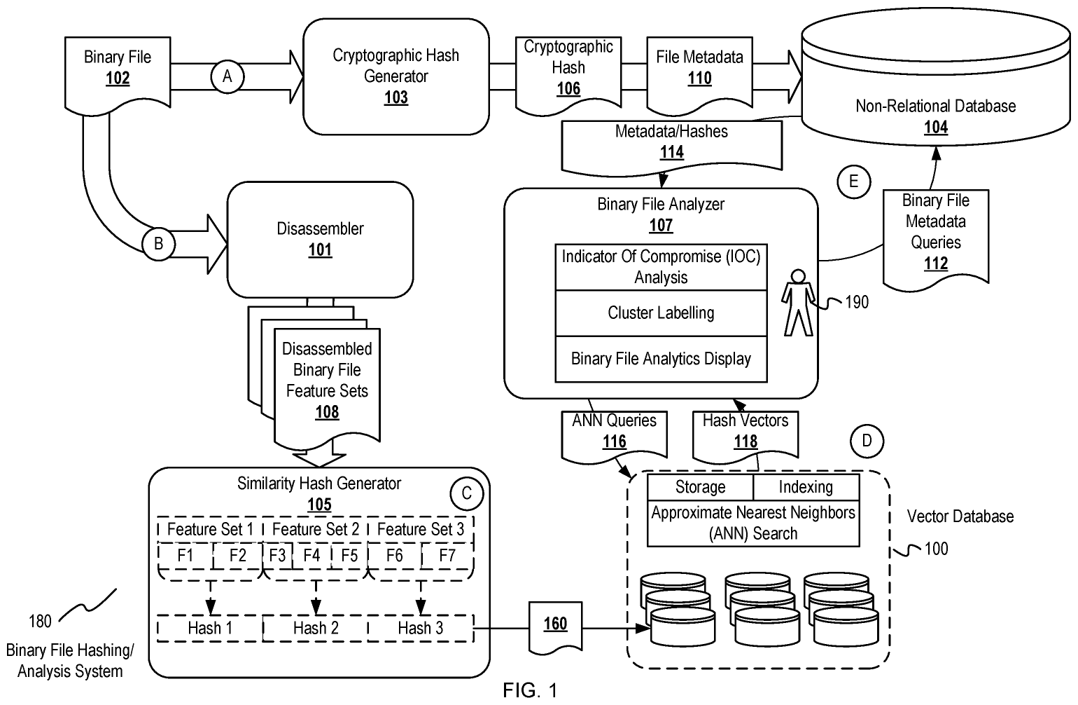

FIG. 1 is a schematic diagram of an example system for labelling and clustering of binary files according to similarity hashes of feature sets of binary files. A binary file hashing/analysis system (system) 180 comprises various components for hashing, metadata generation, and storage for binary files as they are received and analytics are requested by a user or user-enabled settings of the system 180. Similarity hash vectors are generated by a similarity hash generator 105 that communicates generated hash vectors to a vector database 100. Use of the vector database 100 facilitates scalable storage and retrieval of hash vectors for binary files. The vector database 100 is in communication with a binary file analyzer (analyzer) 107 that performs approximate nearest neighbor searches on the vector database 100 to generate clusters of binary files that indicate malicious, unknown, and benign verdicts of binary files stored therein. The analyzer 107 further performs analytics such as IOC analysis in association with sets/clusters of binary files and communicates with a non-relational database 104 to stratify and analyze binary files according to various metadata fields.

FIG. 1 is annotated with a series of letters A-E. Each stage represents one or more operations. Although these stages are ordered for this example, the stages illustrate one example to aid in understanding this disclosure and should not be used to limit the claims. Subject matter falling within the scope of the claims can vary from what is illustrated. To exemplify, operations at stages A-C generate and store of hashes and metadata in association with binary files, and operations at stages D-E analyze binary files based on the generated metadata and hashes. These operations are depicted as occurring sequentially. However, in embodiments, stages A-C occur as binary files are received by the system 180, for instance, as binary files are detected for potentially vulnerable execution by a firewall (not depicted), while stages D-E can occur according to a preset schedule (e.g., every day), upon user request, when a sufficient number of binary files has been detected and processed according to operations at stages A-C, etc.

At stage A, a cryptographic hash generator 103 receives a binary file 102 detected by the system 180. The cryptographic hash generator 103 generates a cryptographic hash 106 and file metadata 110 for the binary file 102 that are communicated to the non-relational database 104. The cryptographic hash 106 comprises a compressed representation of the binary file 102 that purposes as a compact identifier for the binary file 102 once stored in the non-relational database 104. The choice of cryptographic hash function by the cryptographic hash generator 103 is low collision, i.e., a hash function with the property that hashes for distinct binary files are different with high probability. For instance, any of the Secure Hash Algorithms (SHAs) can be chosen. Other choices of efficiently computable and storable identifiers that are unique with high probability can be chosen by the cryptographic hash generator 103.

The cryptographic hash generator 103 further generates metadata such as file metadata 110 from the binary file 102. Exemplary metadata comprise a binary file type, a binary file architecture, and a binary file size. Additionally, the file metadata 110 comprise any malicious or binary verdict associated with the binary file 102, for instance when the binary file 102 is associated with a known malware attack, when the binary file 102 has been evaluated as malicious or benign by a domain-level expert, etc. The cryptographic hash generator 103 can identify the binary file type (for instance, based on a filename extension) and extract metadata fields according to standardized formats for the identified binary file type. For instance, when the binary file 102 is a Executable and Linkable Format (ELF) file, the cryptographic hash generator 103 can detect the file type by one of the extensions “.axf”, “.bin”, “.elf”, etc., 32- or 64-bit format can be extracted from a corresponding field in an ELF header, and the binary file size can be determined by counting a number of bits in the binary file 102.

At stage B, a disassembler 101 receives the binary file 102 and generates disassembled binary file feature sets (feature sets) 108 which the disassembler 101 communicates to the similarity hash generator 105. The disassembler 101 performs decoding, unpacking, parsing, disassembly, and decompiling operations on the binary file 102 to generate a control flow graph and other software artifacts. The disassembler 101 can be a 3^{rd} party (e.g., open-source) disassembler such as Radare2. Subsequently, each of the feature sets 108 is generated from a distinct feature set corresponding to a software artifact extracted by the disassembler 101.

Exemplary software artifacts comprise named functions, unnamed functions, function categories, referenced strings, and non-referenced strings. Feature values for the feature set of the named function artifact comprise 2-grams for named functions generated by determining an identifier that called the named function and an identifier that the named function calls during execution, wherein the 2-gram comprises the pair of function identifiers. Feature values for the feature set of the unnamed function artifact comprise 2-grams for unnamed functions equivalently generated. Each of the 2-grams for named and unnamed functions comprise identifiers of the corresponding call-in and call-out functions, wherein identifiers for the unnamed functions are generated according to a name generation scheme that maps unique functions to unique identifiers. For instance, the identifiers of unnamed functions can comprise sequences of call types for each line of assembly code therein.

Feature values for the feature set of the function categories artifact comprise strings that indicate categories for each function, optionally comprising identifiers of the corresponding functions (with identifiers of unnamed functions equivalently generated as described above). Feature values for the feature set of referenced strings comprise referenced strings in the assembly code. Feature values of the feature set for non-referenced strings comprise non-referenced strings in the assembly code. Each of the feature values given above for each feature set comprises one or more strings (resulting in a single string occurring according to predefined syntax such as a white space character between each string). The ordering of strings can occur, for instance, according to order of occurrence of corresponding functions/strings during execution of the binary file 102.

At stage C, the similarity hash generator 105 generates a hash vector 160 for each of the feature sets 108 and stores the hash vector 160 in the vector database 100. Unlike typical hash functions that seek to minimize collisions, the similarity hash generator 105 applies a similarity hash function to each of the feature sets 108 that maps similar feature sets to similar hashes and dissimilar feature sets to dissimilar hashes. The notion of “similar” and dissimilar” are according to a chosen distance metric for feature sets (e.g., a distance metric on strings) and a chosen distance metric for hashes. To exemplify, the locality sensitive hash function for MinHash is chosen such that the distance metric between feature sets is the Jaccard distance and the distance metric between hashes is the Manhattan/Hamming distance between hashes (note that these are equivalent for binary vectors). Each of the hashes for each of the feature sets 108 is stored in the hash vector 160 according to a preconfigured order that is fixed across each binary file for which the hashes are generated, and the hash vector 160 further indicates feature sets not present in the binary file 102 that do not have hashes. For instance, assembly code for a binary file may not have non-referenced or unnamed functions, and the feature sets for these artifacts would be empty. The hash vector 160 comprises indications of an identifier of the binary file 102 (e.g., the cryptographic hash 106) as well as indications of any known malicious or benign verdicts associated with the binary file 102.

At stage D, when clustering hash vectors of binary files, the analyzer 107 queries the vector database 100 with ANN queries 116, and the vector database 100 returns hash vectors 118. Shards in the vector database 100 are instantiated when storing hashes of binary files such that they are optimized for ANN search according to specified hash functions and distance metrics. For instance, for the above example of MinHash, the similarity hash generator 105 specifies to the vector database 100 that the distance metric between hashes is Hamming distance. The ANN queries 116 then comprise hashes, and the vector database 100 is configured for efficient retrieval of top-k ANN search given a hash (i.e., top-k ANN hashes), where k is a parameter that is tuned by the analyzer 107. For instance, for a locality-sensitive hash function, ANN search is performed according to the locality-sensitive hashing algorithm for nearest neighbor search (as configured by the vector database 100).

The analyzer 107 generates an ANN query 116 for each binary file corresponding to a hash vector in the vector database 100. When the analyzer 107 receives a new top-k ANN list for a queried hash function in the hash vectors 118 returned by the vector database 100, the analyzer 107 determines whether an existing cluster has been initialized with any of the returned hash vectors. If such a cluster has been initialized, then the returned hash vectors are added to the existing cluster and duplicate hash vectors are deduplicated. Otherwise, a new cluster is initialized with the queried hash vector and its top-k ANNs. This occurs until every hash vector corresponding to a binary file in the vector database 100 has been queried.

Once each of the clusters has been generated, each cluster is assigned a malicious, benign, or unknown verdict according to known malicious/benign verdicts. For each cluster, if the consensus verdict is malicious or benign with sufficient confidence (e.g., above 80%/20% split) and, optionally, if there is a sufficient number of hash vectors with known verdicts, then the cluster is assigned a label corresponding to the consensus verdict. Otherwise, the cluster is assigned an unknown label and can be flagged for further inspection by a user 190. The analyzer 107 can query the non-relational database 104 to determine any known malicious/benign verdicts (for instance, with a logical query that asks whether a verdict field is present).

Once an initial set of clusters and labels are generated by the analyzer 107, subsequent re-clustering operations occur by reiterating the clustering and label assignment operations above with the additional hash vectors added to the vector database 100. In some embodiments, during re-clustering, generation of ANN queries by the analyzer 107 is limited to hash vectors added subsequent to most recent clustering, and the above algorithm for determining whether a hash vector and ANNs are present in an existing cluster, assigning the hash vector and ANNs to the existing cluster while deduplicating, and otherwise initializing a new cluster with the hash vector and ANNs is again used with these subsequent hash vectors.

At stage E, the analyzer 107 queries the non-relational database 104 with binary file metadata queries (queries) 112 and the non-relational database 104 returns metadata/hashes 114. The queries 112 comprise criteria for one or more binary files for which metadata, cryptographic hash identifiers, and/or flaw/vulnerability analysis have been generated. For instance, the queries 112 can comprise a query specifying a file type and lower and upper threshold sizes for binary files, and the metadata/hashes 114 can comprise metadata and cryptographic hash identifiers for binary files having the file type with sizes above the lower threshold and below the upper threshold. The queries 112 can further specify specific fields to return for binary files satisfying any criteria therein, for instance to return binary file type, binary file size, binary file architecture, and any associated IOCs. This allows for analysis of binary files along certain strata—to exemplify, identification of frequency of particular IOCs for ELF binary files under 5 megabytes with 64-bit architecture. The queries 112 can be generated by the user 190 interacting with the analyzer 107 via a dashboard that facilitates specifying criteria for certain metadata fields of binary files (not depicted). Binary files can be further analyzed and results displayed to the user 190 based on verdicts determined via clustering at stage D. The user 190 can update verdicts and/or IOCs for sets/clusters of binary files according to domain level knowledge and, based on detection of high-risk malicious verdicts, can notify corresponding users/firewalls of the potentially vulnerable binary files based on identified metadata according to these analytics.

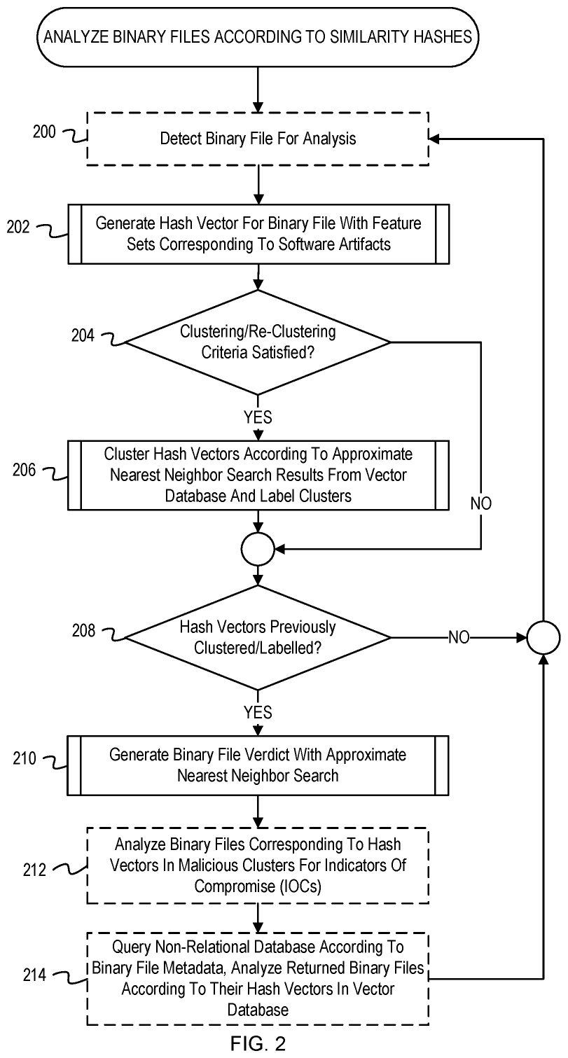

FIGS. 2-6 are flowcharts of example operations for analyzing binary files according to similarity hashes using clustering. The example operations are described with reference to a binary file hashing/analysis system, a vector database, and a non-relational database for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for analyzing binary files according to similarity hashes. At block 200, a binary file hashing/analysis system (system) detects binary files for analysis. The binary files are detected according to attempted execution or inspection at an endpoint user device, association of binary files with known malware campaigns by a firewall, detection of binary files present in 3^{rd} party repositories, etc. Block 200 is depicted with a dashed outline to indicate that detection and subsequent analysis of binary files is ongoing and independent of and/or in parallel with analysis of any additional binary files that are detected until an external trigger (e.g., an administrator of the system) terminates binary file analysis.

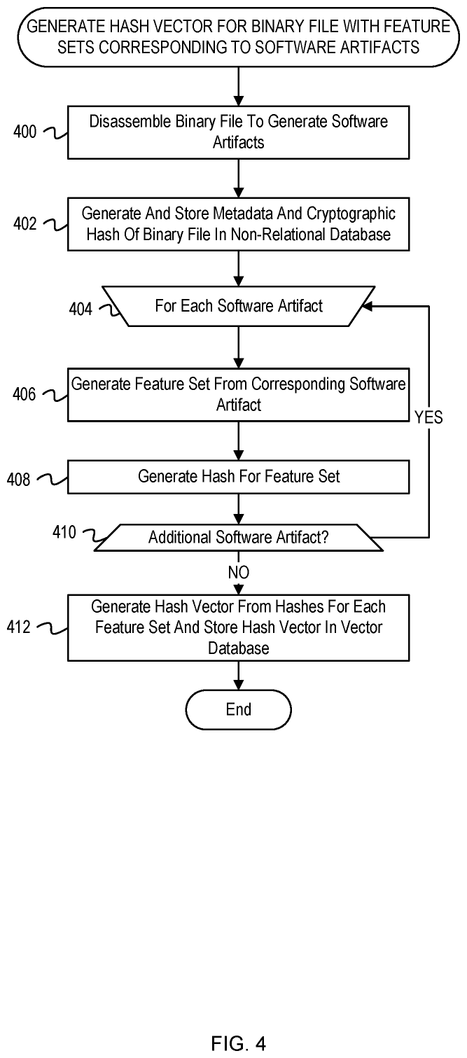

At block 202, the system generates a hash vector for a binary file with feature sets corresponding to software artifacts. The hash vector comprises hashes of feature sets derived from various features representing aspects of execution/functionality of the binary file. Each feature set corresponds to a software artifact of the binary file obtained during disassembly. The operations at block 202 are depicted in greater detail in reference to FIG. 4.

At block 204, the system determines whether clustering/re-clustering criteria are satisfied. The criteria can be that no clusters have been previously instantiated and a sufficient number of binary files have been detected, that a sufficient number of binary files have been detected subsequent to most recent clustering, that a predetermined time interval has elapsed since most recent clustering (e.g., a day), that a user has indicated initiation of clustering/re-clustering through a portal of the system, etc. If the criteria are satisfied, flow proceeds to block 206. Otherwise, flow skips to block 208.

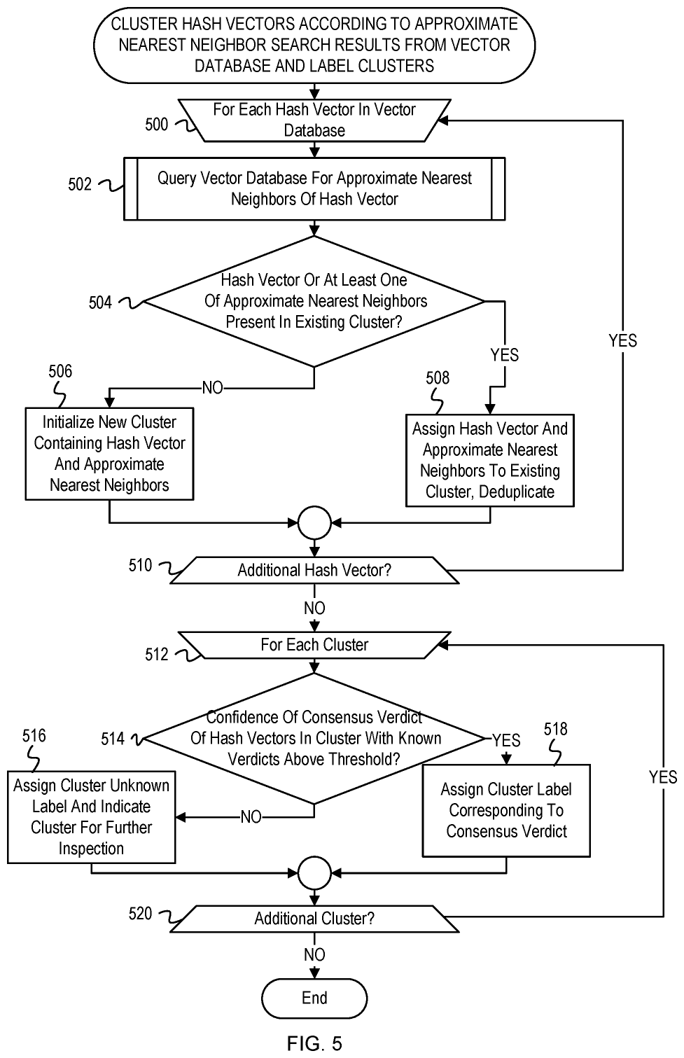

At block 206, the system clusters hash vectors according to ANN search results from a vector database and labels the clusters. Clusters are initialized according to ANNs for hash vectors returned by the vector database and ANNs are further added to existing clusters containing hash vectors or their ANNs. Clusters are labelled based on consensus labels of binary files corresponding to hash vectors therein that have known malicious/benign verdicts. The operations at block 206 are described in greater detail in reference to FIG. 5.

At block 208, the system determines whether hash vectors for binary files have been previously clustered/labelled. If hash vectors have been previously clustered/labelled, flow proceeds to block 210. Otherwise, flow returns to block 200.

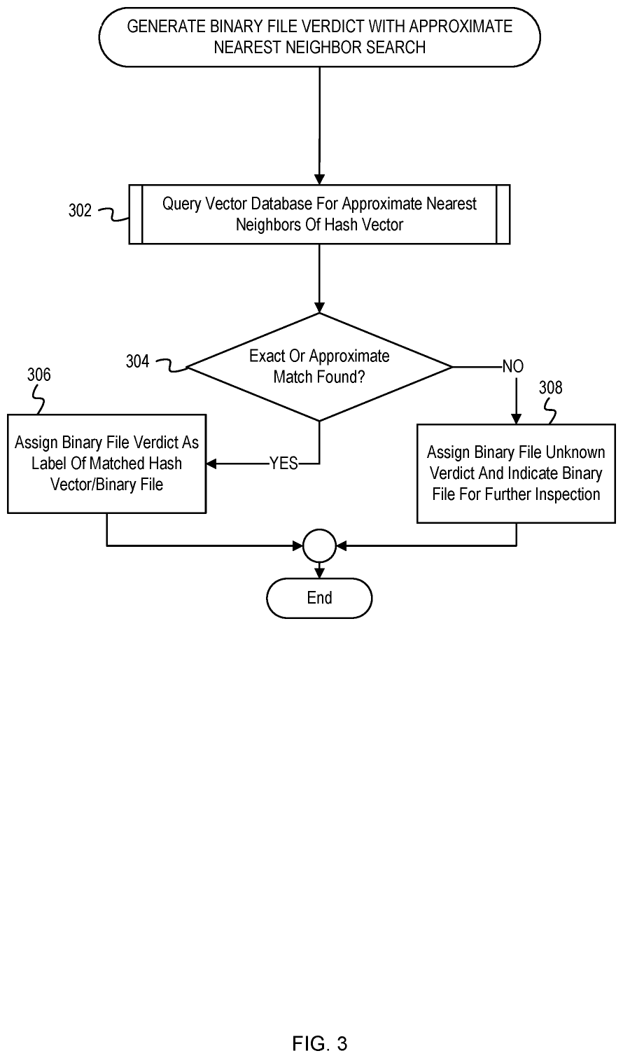

At block 210, the system generates a binary file verdict with ANN search. The binary file verdict is generated by querying a vector database for ANNs of the hash vector of the binary file and determining whether any of the returned ANNs are an exact or approximate match. The verdict is assigned as a verdict of the binary file corresponding to a closest hash vector that is an exact or approximate match and is according to a label of a cluster containing the closest hash vector. The operations at block 210 are depicted in greater detail in reference to FIG. 3.

At block 212, the system analyzes binary files corresponding to hash vectors in malicious clusters for IOCs. For instance, the system can generate signatures of binary files and compare them against known signatures for certain IOCs. Based on a sufficient number and/or percentage of IOCs detected in each cluster, the system can add indicators of corresponding IOCs and, in some instances, their frequency of occurrence to store in a non-relational database for the binary files. Clusters with sufficiently high correlation with certain IOCs can be flagged according to risk levels of the corresponding IOCs.

At block 214, the system queries the non-relational database according to binary file metadata and analyzes returned binary files according to their hash vectors in the vector database. The hash vectors in the vector database are associated with verdicts corresponding to labels of each corresponding cluster. The system queries the non-relational database for certain strata of binary files (i.e., according to file size, file type, and file architecture) and associates the returned binary files with corresponding verdicts.

The system analyzes strata comprising a high percentage of malicious binary files for certain IOCs. The operations at block 210 can be performed by a user specifying strata of binary files via a dashboard of the system.

Blocks 208 and 210 are depicted with dashed outlines. This indicates that corresponding operations related to analysis of binary files occur independently from the aforementioned operations for detection, verdict generation, and clustering of binary files. These operations occur once clusters of binary files with corresponding labels are generated and correspond to the use the results of said clustering to generate corresponding analytics. Corresponding analysis for operations at blocks 208 and 210 can occur based on user-specified queries through a portal of the system or can be generated according to automated systems for detection of malicious/compromised sets of binary files.

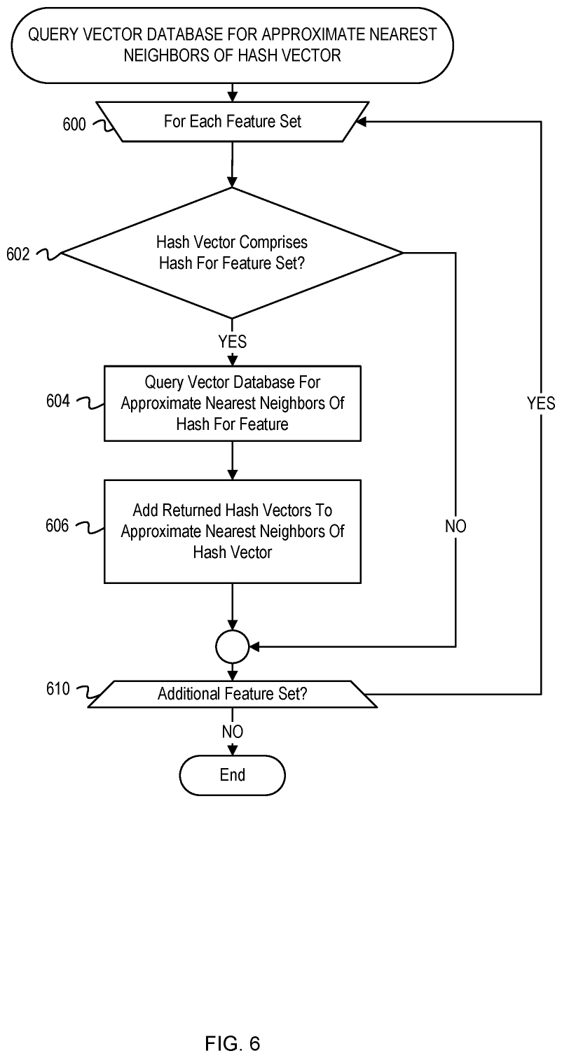

FIG. 3 is a flowchart of example operations for generating a binary file verdict with ANN search. At block 302, the system queries a vector database for ANNs of the hash vector. The queries comprise a distinct query for each hash in the hash vector of the binary file and the ANNs returned by the vector database are combined ANNs for each hash in the hash vector. The operations at block 302 are depicted in greater detail in reference to FIG. 6.

At block 304, the system determines whether any of the results from the ANN queries to the vector database corresponds to an exact or approximate match of the hash vector. Exact and approximate matches are defined according to a threshold distance between hash vectors. While ANN search is performed for each hash in hash vectors, distances across hashes are generated when determining exact or approximate matches. For instance, distance between two hash vectors can be a weighted average of distances between each corresponding hash, with the weights accounting for the number of feature sets the hash vectors have in common (i.e., whose corresponding features are present in both binary files). The system can specify a threshold distance such that results of the

ANN search with distance to the hash vector above the threshold distance do not comprise exact or approximate matches. Note that exact matches correspond to identical hash vectors returned from the ANN search along the hashes that they share. If an exact or approximate match is found, flow proceeds to block 306. Otherwise, flow proceeds to block 308.

At block 306, the system assigns a binary file verdict for the binary file corresponding to the hash vector as a label of the exact or approximate matched hash vector/binary file. The label of the exact or approximate matched hash vector/binary file corresponds to the label of the cluster containing the exact or approximate matched hash vector. When multiple exact or approximate matches are returned from the ANN search, then a hash vector for assigning the binary file verdict is chosen as a closest hash vector to the generated hash vector, wherein ties are broken randomly.

At block 308, the system assigns the binary file an unknown verdict and indicates the binary file for further inspection. For instance, the binary file can be indicated in a dashboard to a domain-level expert along with any associated metadata and closest ANN search results that were not exact or approximate matches.

FIG. 4 is a flowchart of example operations for generating a hash vector for a binary file with features sets corresponding to software artifacts. At block 400, a binary file hashing/analysis system (system) disassembles a binary file to generate software artifacts. For instance, the software artifacts can comprise named functions, unnamed functions, function types, referenced strings, and/or non-referenced strings present in assembly code generated from disassembly. Disassembly is performed by a disassembly component of the system, which can comprise an off the shelf disassembler such as Radare2.

At block 402, the system generates and stores metadata and a cryptographic hash of the binary file in a non-relational database. The cryptographic hash comprises a (probabilistically) unique identifier of the binary file generated by a low collision hash function such as, for instance, any of the SHA hash functions. The metadata comprise a binary file type, a binary file architecture, and/or a binary file size that can be extracted/generated according to various binary file types. The binary file size can comprise file size after headers are removed. Moreover, additional/alternative metadata can be generated from assembly code for the binary file such as number of functions, function types, etc. Storing the metadata and cryptographic hash in a non-relational database allows for scalability and addition of various, potentially complex metadata dependencies for each binary file in a flexible data structure.

At block 404, the system begins iterating through software artifacts corresponding to one or more feature sets. Example operations at each iteration occur at block 406 and block 408. At block 406, the system generates a feature set from the corresponding software artifact. An example feature set for the named functions artifact comprises 2-grams of identifiers for call-in and call-out functions for the named functions. An example feature set for the unnamed functions artifact also comprises 2-grams generated equivalently, with function identifiers for unnamed functions comprising sequences of instruction types for each line of assembly code in the functions. An example feature set for the function type artifact comprises identifiers of function types for each function. An example feature set for the referenced and non-referenced string artifacts comprises referenced strings and non-referenced strings, respectively. Each feature set comprises strings that can be concatenated according to predefined syntax and can further comprises associated identifiers of any associated functions (with identifiers for unnamed functions generated as above). Feature sets have variable length across binary files according to assembly code of those binary files (e.g., binary files with varying number of functions and varying number of reference strings). Subsequent hashing reduces each feature set (if the corresponding feature/artifact exists in the binary files) to a fixed length hash.

At block 408, the system applies a hash function to generate a hash for the feature set. The hash function converts the feature set, which is a string, to a binary vector or other numerical data structure that allows for pairwise comparisons in a numerical vector space. To exemplify, the MinHash function can be applied to the feature set. The hash function is chosen as a similarity hash so that similar binary files are mapped to similar hashes and dissimilar binary files are mapped to dissimilar hashes. In the case of MinHash, feature sets that are similar according to the Jaccard distance are mapped to similar binary vectors in the Manhattan/Hamming distance, and equivalently for dissimilar feature sets. The feature sets capture functionality on execution (i.e., present in assembly code) of the corresponding binary files, so these hashes capture similarity in more than just the binary file code-the binary file code can be manipulated so that similar binary files have significantly different functionality.

At block 410, the system continues iterating through software artifacts. If there is another software artifact for hash generation, flow returns to block 404. Otherwise, flow proceeds to block 412.

At block 412, the system generates a hash vector from hashes for each feature set and stores the hash vector in a vector database. The system stores each hash in the data structure comprises the hash vector and, for each feature set not present in the binary file, stores an indication that the feature set is empty. The vector database is configured for efficient, scalable storage and ANN search of hash vectors according to the hash function used. Shards in the vector database can be dynamically instantiated and deleted according to load-balancing and overall storage in the vector database. The hash vector can further be stored in association with the cryptographic hash or other unique identifier of the corresponding binary file as well as any known malicious or benign verdict.

FIG. 5 is a flowchart of example operations for clustering hash vectors according to ANN results for a vector database and labelling the clusters. At block 500, a binary file hashing/analysis system (system) begins iterating through hash vectors in a vector database. While the example iterations occur per hash vector, in some embodiments, each iteration can comprise a batch of hash vectors, and the vector database can be queried per batch for ANNs of each hash vector in the batch. Hash vectors can be batched by the system according to known similarity (e.g., hash vectors corresponding to binary files from same sources or having known similar functionality) and associated as batches in a non-relational database for retrieval during querying.

At block 502, the system queries a vector database for ANNs of the hash vector at the current iteration. The operations at block 502 are depicted in greater detail in reference to FIG. 6. The query specifies hashes of the hash vector, and the hash vector can be stored in a separate non-relational database and retrieved by the system prior to querying. The non-relational database can be configured to return all hash vectors in sequence to the system based on a corresponding query to allow the system to iteratively query the vector database for approximate nearest neighbors of the returned hash vectors. The ANN query can specify a threshold distance and/or maximal number of ANNs to return.

At block 504, the system determines whether the hash vector or at least one of its approximate nearest neighbors is present in an existing cluster. If an existing cluster contains the hash vector or at least one of its approximate nearest neighbors, flow proceeds to block 508. Otherwise, flow proceeds to block 506.

At block 506, the system initializes a new cluster containing the hash vector and its approximate nearest neighbors. The system can associate the new cluster with a cluster identifier for subsequent search and retrieval of hash vectors therein

At block 508, the system assigns the hash vector and its ANNs to an existing cluster and deduplicates any assigned hash vectors already present in the existing cluster. Deduplication occurs because a hash vector A can be an approximate nearest neighbor of a hash vector B and vice versa, thus hash vector B would be added twice to the cluster of hash vector A if the cluster of ANNs to hash vector A has already been initialized.

At block 510, the system continues iterating through hash vectors in the vector database. If there is an additional hash vector, flow return to block 500. Otherwise, flow proceeds to block 512.

At block 512, the system begins iterating through clusters.

At block 514, the system determines whether a confidence of a consensus verdict of hash vectors with known verdicts in the cluster at the current iteration is above a threshold. The verdicts comprise verdicts for corresponding binary files that are known to be benign or malicious, for instance binary files associated with known malicious campaigns that have malicious labels, binary files from trusted repositories that have benign labels, etc. For instance, the system can determine whether the consensus verdict is above an 80%/20% threshold of verdicts (i.e., 80% malicious/20% benign or 80% benign/20% malicious) when determining whether the confidence is above the threshold.

The consensus verdict precludes unknown verdicts. The system can additionally determine whether there are enough hash vectors with known verdicts (e.g., above 100) to determine whether the confidence is above the threshold. If the confidence is above the threshold, flow proceeds to block 518. Otherwise, flow proceeds to block 516.

At block 516, the system assigns the cluster an unknown label and indicates the cluster for further inspection. Based on the indication, a domain-level expert can inspect binary files corresponding to hash vectors in the cluster and metadata thereof to determine whether the binary files are malicious or benign. In some instances, the domain-level expert can reassign hash vectors to existing clusters based on knowledge that corresponding binary files are similar to binary files for hash vectors in the existing cluster. Flow proceeds to block 520.

At block 518, the system assigns the cluster with a label corresponding to the consensus verdict. Based on a malicious verdict with sufficient confidence, the system can generate an alert indicating the cluster and can further retrieve metadata, IOCs, etc. for binary files corresponding to the cluster. The metadata and IOCs can be displayed in a dashboard for inspection. Flow proceeds to block 520.

At block 520, the system continues iterating through clusters. If there is an additional cluster, flow returns to block 512. Otherwise, operations in FIG. 5 are complete.

FIG. 6 is a flowchart of example operations for querying a vector database for ANNs of a hash vector. At block 600, a binary file hashing/analysis system (system) begins iterating through feature sets.

At block 602, the system determines whether the hash vector comprises a hash for a feature set. For instance, the hash vector can comprise a header of binary variables indicating whether each feature set is present in the hash vector. If the hash vector comprises the feature set, flow proceeds to block 604. Otherwise, flow skips to block 610.

At block 604, the system queries the vectors database for ANNs of the hash for the feature set. The query specifies the feature set and the hash. In some embodiments, the vector database comprises a separate database instance for each feature set, wherein each separate database stores hashes of binary files for that feature set. The query can further specify a threshold number of ANNs and/or threshold distance for which to return results.

At block 606, the system adds the returned hash vectors to the ANNs of the hash vector. The system deduplicates existing hash vectors in the ANNs of the hash vectors (e.g., according to their corresponding cryptographic hash identifiers).

At block 610, the system continues iterating through feature sets. If there is an additional feature set, operations return to block 600. Otherwise, the operations of FIG. 6 are complete.

### Variations

The foregoing describes storage of metadata and identifiers (i.e., cryptographic hashes) of binary files in a non-relational database and storage of hash vectors generated from locality sensitive hashes of feature sets in a vector database. The example database architectures of a non-relational database and a vector database are provided for illustrative purposes of scalable, efficient database architectures for storage and retrieval. Any database architecture that allows for scalable and efficient storage and retrieval of the aforementioned data can be used.

Hash functions for generating hash vectors from binary file artifacts are above described as locality sensitive hash functions, in particular MinHash. Other types of locality sensitive hash functions and/or other hash functions that map similar binary files to similar hashes and dissimilar binary files to dissimilar hashes can be used. Moreover, multiple (possible randomized, permuted, or transformed) hash functions can be used for each feature value of a binary file artifact. Nearest neighbor search is described as approximate nearest neighbor search according to the approximate nearest neighbor search for locality sensitive hashing algorithm. Other nearest neighbor search algorithms, such as exact nearest neighbor search, can be used depending on scalability and types of hash functions implemented.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 202, 206, 208, and 210 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

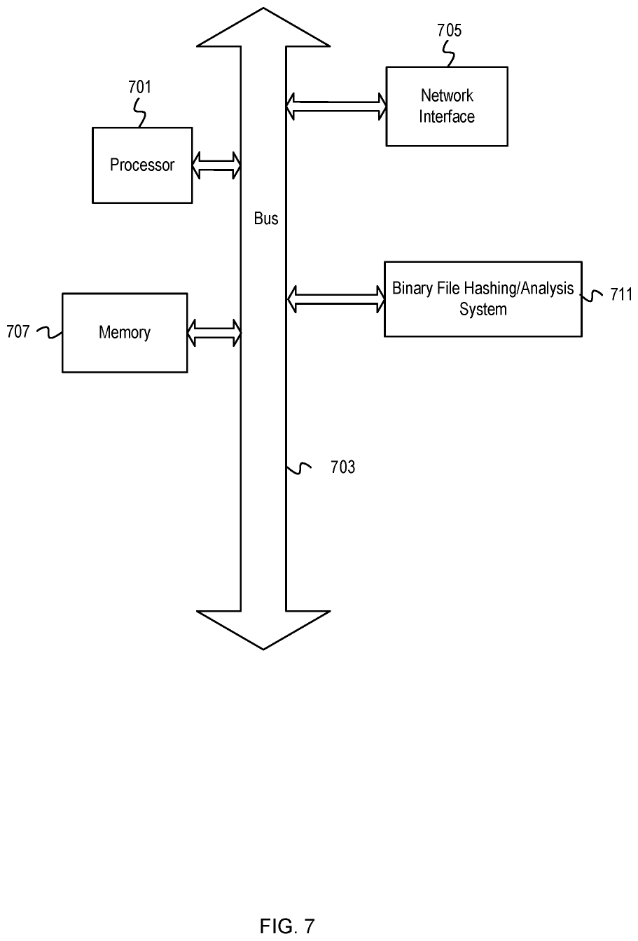

FIG. 7 depicts an example computer system with a binary file hashing/analysis system. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a binary file hashing/analysis system (system) 711. The system 711 generates hash vectors by disassembling binary files to generate feature sets of software artifacts and concatenating locality sensitive hashes of the feature sets. The system 711 further clusters the generated hash vectors with ANN search by storing the hash vectors in a vector database and labels clusters according to known verdicts of corresponding binary files. The system 711 generates and stores analytics such as IOCs and metadata/identifiers of binary files on a non-relational database for analysis in combination with analysis of the hash vectors via clustering. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
disassembling a binary file to generate a plurality of feature sets of the binary file, wherein each of the plurality of feature sets corresponds to an artifact from the disassembled binary file;
hashing each of the plurality of feature sets to generate a first hash vector for the binary file;
identifying a first plurality of binary files with corresponding hash vectors that each match the first hash vector for the binary file, wherein each match is at least one of an exact match and an approximate match, wherein exact and approximate matches of the first hash vector are according to a nearest neighbor search of hash vectors of binary files including the plurality of binary files; and
classifying the binary file according to a verdict for at least one of the first plurality of binary files.

2. The method of claim 1, wherein hashing each of the plurality of feature sets to generate the first hash vector comprises inputting each of the plurality of feature sets into a locality sensitive hashing function to generate a plurality of hashes, wherein the first hash vector comprises the plurality of hashes.

3. The method of claim 1, wherein the nearest neighbor search comprises an approximate nearest neighbor search.

4. The method of claim 3, wherein the approximate nearest neighbor search is according to hamming distance between hash vectors.

5. The method of claim 1, further comprising:
clustering a plurality of hash vectors corresponding to a second plurality of binary files to generate a plurality of clusters, wherein the second plurality of binary files comprises the first plurality of binary files; and
labelling each cluster of the plurality of clusters according to known verdicts of binary files corresponding to hash vectors in the cluster.

6. The method of claim 5, wherein classifying the binary file according to the verdict for at least one of the first plurality of binary files comprises,
determining that the first hash vector is a nearest neighbor of a first cluster of the plurality of clusters; and
indicating the verdict as a label of the first cluster.

7. The method of claim 5, wherein clustering the plurality of hash vectors to generate the plurality of clusters comprises, for each hash vector in the plurality of hash vectors,
determining a subset of the plurality of hash vectors as nearest neighbors of the hash vector; and
based on determining that a first cluster of the plurality of clusters comprises at least one of the subset of the plurality of hash vectors and the hash vector, assigning the subset of the plurality of hash vectors and the hash vector to the first cluster.

8. The method of claim 7, further comprising, based on determining that none of the plurality of clusters comprise at least one of the subset of the plurality of hash vectors and the hash vector, initializing a second cluster of the plurality of clusters with the subset of the plurality of hash vectors and the hash vector.

9. The method of claim 1, wherein the plurality of feature sets comprises two or more of named functions features, unnamed functions features, function categories features, referenced strings features, and non-referenced strings features.

10. A non-transitory machine-readable medium having program code stored thereon, the program code comprising instructions to:
generate a plurality of clusters for a plurality of hash vectors corresponding to a plurality of binary files according to nearest neighbor search on hash vectors in the plurality of hash vectors, wherein each of the plurality of hash vectors comprises hashes for a corresponding one of the plurality of binary files, wherein each of the hashes is a hash of a feature set generated from one of a plurality of binary file artifacts;
assign each cluster of the plurality of clusters a label according to known labels of binary files in the plurality of binary files corresponding to hash vectors in the cluster;
determine that a first hash vector of a first binary file in the plurality of binary files is at least one of an exact and an approximate match of a second hash vector in a first cluster of the plurality of clusters; and
assign a verdict for the first binary file corresponding to a label of the first cluster.

11. The non-transitory machine-readable medium of claim 10, wherein the instructions to generate the plurality of clusters for the plurality of hash vectors comprise instructions to, for each hash vector of the plurality of hash vectors,
determine a subset of the plurality of hash vectors that are nearest neighbors of the hash vector; and
based on a determination that a first cluster of the plurality of clusters comprises at least one of the subset of the plurality of hash vectors and the hash vector, assign the subset of the plurality of hash vectors and the hash vector to the first cluster.

12. The non-transitory machine-readable medium of claim 11, further comprising instructions to, based on a determination that none of the plurality of clusters comprise at least one of the subset of the plurality of hash vectors and the hash vector, initialize a second cluster of the plurality of clusters with the subset of the plurality of hash vectors and the hash vector.

13. The non-transitory machine-readable medium of claim 10, wherein the instructions to determine that the first hash vector is at least one of an exact and an approximate match of the second hash vector comprise instructions to determine that the second hash vector is an approximate nearest neighbor of the first hash vector.

14. The non-transitory machine-readable medium of claim 10, wherein the hashes for each of the plurality of binary files comprise locality sensitive hashes of feature sets generated from the plurality of binary file artifacts.

15. The non-transitory machine-readable medium of claim 10, wherein the plurality of binary file artifacts comprises two or more of named functions, non-named functions, function types, referenced strings, and non-referenced strings in assembly code of binary files.

16. An apparatus comprising:
a processor; and
a machine-readable medium having instructions stored thereon that are executable by the processor to cause the apparatus to,
generate a first hash vector for a first binary file, wherein the first hash vector comprises hashes generated from artifacts of the first binary file;
identify a subset of a plurality of hash vectors corresponding to a plurality of binary files as nearest neighbors to a first hash vector corresponding to a first binary file, wherein each of the plurality of hash vectors comprise vectors of hashes generated from artifacts of corresponding binary files; and
based on a determination that a first cluster in a plurality of clusters of hash vectors comprises at least one hash vector of the subset of the plurality of hash vectors, indicate a verdict for the first binary file corresponding to a label of the first cluster.

17. The apparatus of claim 16, wherein the instructions to identify the subset of the plurality of hash vectors as nearest neighbors to the first hash vector comprise instructions executable by the processor to cause the apparatus to identify the subset of the plurality of hash vectors as approximate nearest neighbors of the first hash vector.

18. The apparatus of claim 16, wherein the hashes generated from artifacts of the first binary file comprise locality sensitive hashes generated from artifacts of the first binary file.

19. The apparatus of claim 16, wherein each cluster of the plurality of clusters is labelled based, at least in part, on known verdicts of binary files corresponding to at least a subset of hash vectors in the cluster.

20. The apparatus of claim 16 wherein the artifacts of the first binary file comprise two or more of named functions, non-named functions, function types, referenced strings, and non-referenced strings in assembly code of binary files.
